(19) United States
(12) Patent Application Publication
(10) Pub. No.: US 2003/0163693 A1
(43) Pub. Date: Aug. 28, 2003

(54) Detection of duplicate client identities in a communication system

(75) Inventor: Alexander Medvinsky, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: General Instrument Corporation, Horsham, PA

(21) Appl. No.: 10/086,302

(22) Filed: Feb. 28, 2002

(51) Int. Cl. H04L 9/00

(52) U.S. Cl. 713/169

(57) ABSTRACT

A system for detecting clones in a communication network. The system of this invention includes a KDC (key distribution center), coupled to clients and application servers through the communication network. When a client wishes to access an application server, it contacts the KDC. The KDC then verifies whether the client is authorized to access the application server. In one aspect, this verification is done by performing an authenticated Diffie-Hellman key exchange. After the client is authenticated by the KDC, it issues a ticket containing a session key. In one aspect, this ticket is valid for a designated duration. In another aspect, the KDC simply records when the ticket was issued. After the ticket is issued, the session key is used by the client for authenticating its access request and accessing the application server. A clone wishing to access the application server, needs to contact the KDC to perform its own authenticated key agreement, to obtain a ticket with a new random session key. The clone having duplicated the identity of the client, now contacts the KDC to request access to the application server. The KDC then checks whether the access request is prior to expiration of the ticket previously issued to the authorized client. If so, the access request is flagged as a possible fraudulent request. In this manner, the present invention grants access to authorized clients while preventing access to unauthorized clients. Note that cloning detection may take place at the KDC. Or, it may occur at the application server to which access is being sought.

### BACKGROUND OF THE INVENTION

The present invention relates generally to the field of data communication and more specifically to rights management for detecting duplicate client identities.

Conventional digital rights management systems for securing content transmitted through communication networks such as the Internet are generally well known. Such rights management systems often employ encryption/decryption techniques. Encryption is the conversion of data into an unintelligible form, e.g., ciphertext, that is difficult to understood by a consumer. Decryption converts the encrypted content back into its original form such that it becomes intelligible.

The correct decryption key is required for recovering the encrypted information content. A key is a binary string used as a parameter for both encryption and decryption algorithms. Generally, the larger the key, the more difficult it becomes to recover the content without access to the key. Generally, there are two types of key schemes for encryption/decryption systems, namely, (1) PKS (public key systems) or asymmetric systems which utilize two different keys, a private key for decryption, or signing, and public key for encryption, or verifying; and (2) nonpublic key systems that are known as symmetric, or secret key systems in which the encryption and decryption keys are the same, and the decryption key can be calculated from the encryption key.

For key management systems, for example, symmetric keys are distributed to clients for encrypting and authenticating messages to servers. Note that each symmetric key is secret and is associated with a particular client. Herein lies a first problem. Cloning compromises a client's private key or permanent symmetric key that is used for initial authentication with a KDC such that this key and the client's identity are copied by the clone. In this manner, the clone uses the original client identity to authenticate to a KDC and to obtain session keys then used to receive services, entitlements and content intended for the authorized client. The cloning phenomena is particularly prevalent on VoIP (voice over Internet protocols) networks which are susceptible to unauthorized phone calls. Pirates can clone identities of consumers authorized for telephony services. These services are then freely used or sold at reduced rates. A similar problem exists with distribution of multimedia services where multimedia content is acquired by clones without authorization.

One conventional technique for resolving cloning issues is to store client private and symmetric keys in dedicated hardware devices. Examples of hardware devices are smart cards and ASICs (application specific integrated circuits). While hardware devices may deter, if not prevent outright cloning, they are expensive to develop. Even if cost were immaterial, development of hardware devices do require considerable time. Another disadvantage of hardware devices is that they are not easily modifiable.

A further conventional technique for preventing cloning is by employing fraud management systems. These systems are typically used in multimedia and telephony networks. The problem in multimedia networks is that a user can subscribe for content and knowingly distribute keys to unauthorized users. In telephony networks, the user may subscribe with false information in order to pirate telephone calls.

In both cases, fraud management systems monitor and record client use patterns. For example, a telephone call is probably unauthorized if placed within minutes of a another call placed miles away from where the telephone call was placed. This pattern is detected by the client use system, and the telephone call is denied. However, because client use patterns vary substantially, fraud management systems must be capable of detecting many different client use patterns.

Furthermore, client use patterns, however irregular can be those of authorized users. The fraud management system could mischaracterize these client patterns as being unauthorized, thus, causing discontinuance of authorized services. Even if the aforementioned disadvantages were overcome, many fraud management systems cannot function beyond the particular applications for which they were intended. For example, a wireless telephony fraud management system cannot function in a digital rights management system.

Therefore there is a need to overcome one or more of the aforementioned disadvantages and this invention meets this need.

### BRIEF SUMMARY OF THE INVENTION

According to a first aspect of the present invention, a system for detecting clones in a communication network is disclosed. A clone is an unauthorized entity that has duplicated the identity and the symmetric key of an authorized client. In this manner, the clone can receive services, entitlements and content intended for the authorized client.

The system of this invention includes a KDC (key distribution center), coupled to clients and application servers through the communication network. When a client wishes to access an application server, it contacts the KDC. The KDC then verifies whether the client is authorized to access the application server. In one aspect, this verification is by performing an authenticated Diffie-Hellman key exchange. Diffie-Hellman is a well-known public key algorithm for independently generating symmetric keys. With this algorithm, each party on each end can generate the same symmetric key for encrypting/authenticating messages.

After the client is authenticated by the KDC, it issues a ticket containing a session key. In one aspect, this ticket is valid for a designated duration. In another aspect, the KDC simply records when the ticket was issued. After the ticket is issued, the session key is used by the client for authenticating its access request and accessing the application server. Once authenticated, access is granted to the client.

The Diffie-Hellman key exchange forces all entities to contact the KDC to obtain access to application servers. This is because, with Diffie-Hellman, each party randomly generates a new public/private key pair before a new key exchange. And, no more than the public Diffie-Hellman keys are exchanged over communication lines. Each party uses its own private Diffie-Hellman key and the public Diffie-Hellman key of the other party to generate an identical symmetric key on both sides. Because the Diffie-Hellman key pairs are generated on the fly, it is relatively difficult to to make copies of them in advance and then copy into clones. Thus, symmetric session keys are difficult to obtain by a clone that is simply snooping the line. In this manner, a clone wishing to access the application server, needs to contact the KDC to perform its own authenticated key agreement, to obtain a ticket with a new random session key.

The clone having duplicated the identity of the client, now contacts the KDC to request access to the application server. The KDC then checks whether the access request is prior to expiration of the ticket previously issued to the authorized client. If so, the access request is flagged as a possible fraudulent request. It is probable the access request is from a clone, because an authorized client would not keep requesting for tickets while its ticket is valid. Such continuous requests, however, may occur when the authorized client loses it ticket. For such cases, the access request is flagged for further investigation.

Alternately, the access request may be denied after a designated number of requests. For example, the designated number of requests may be six, after which further requests during the ticket validity period are denied.

In this manner, the present invention grants access to authorized clients while preventing access to unauthorized clients. Note that cloning detection may take place at the KDC. Or, it may occur at the application server to which access is being sought.

Further, the KDC may be the application server such that it is accessible using a ticket granting ticket (TGT).

According to another aspect of the present invention, a method for detecting clones in a communication network is taught. The method includes the step of providing a ticket granting ticket (TGT) for accessing a KDC. The TGT has a session key valid for a time duration T.

The method further includes the step of receiving a first request to access the KDC. The first request may be received from an authorized client for example. Note that first request is accompanied by the TGT.

A further step includes receiving a second request to access the KDC. The second request may be received from a clone, for example. Such a clone typically has the same identity as the client. If the second request is received during the time duration T, the second request is either flagged or denied to prevent access to the KDC.

Advantageously, the clone detection system of the present invention is flexible and avoids the complexity and disadvantages associated with conventional fraud management systems.

### BRIEF DESCRIPTION OF THE DRAWINGS

FIG. 1 is a block diagram of a communication network in which the present invention is employed for detecting duplicate identities in accordance with a first embodiment of the present invention.

FIG. 2 is a flow chart of a method employing the KDC for detecting clones in accordance with one embodiment of the present invention.

### DETAILED DESCRIPTION OF THE INVENTION

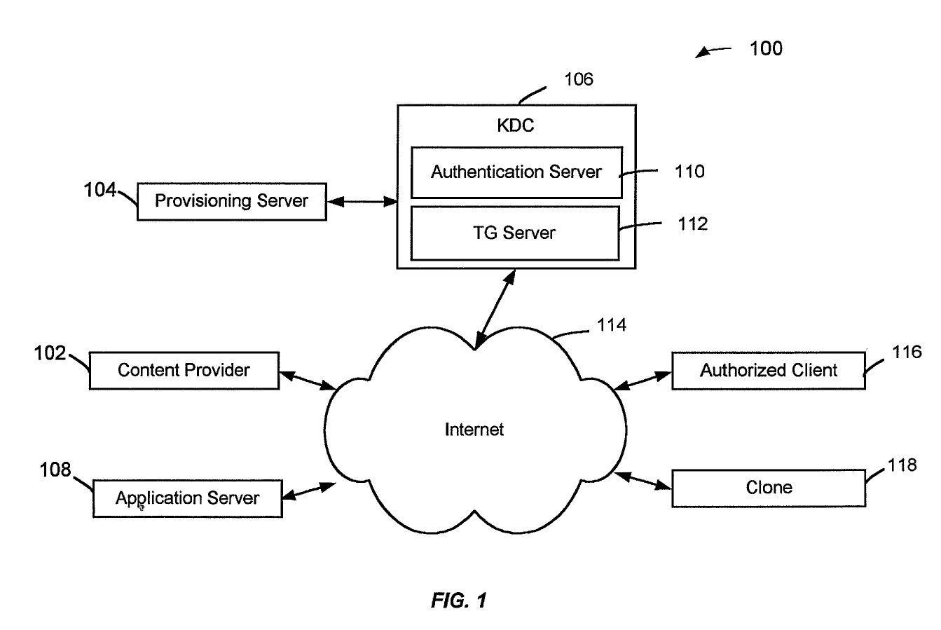

FIG. 1 is a communication network 100 in which duplicate identities are detected in accordance with a first embodiment of the present invention.

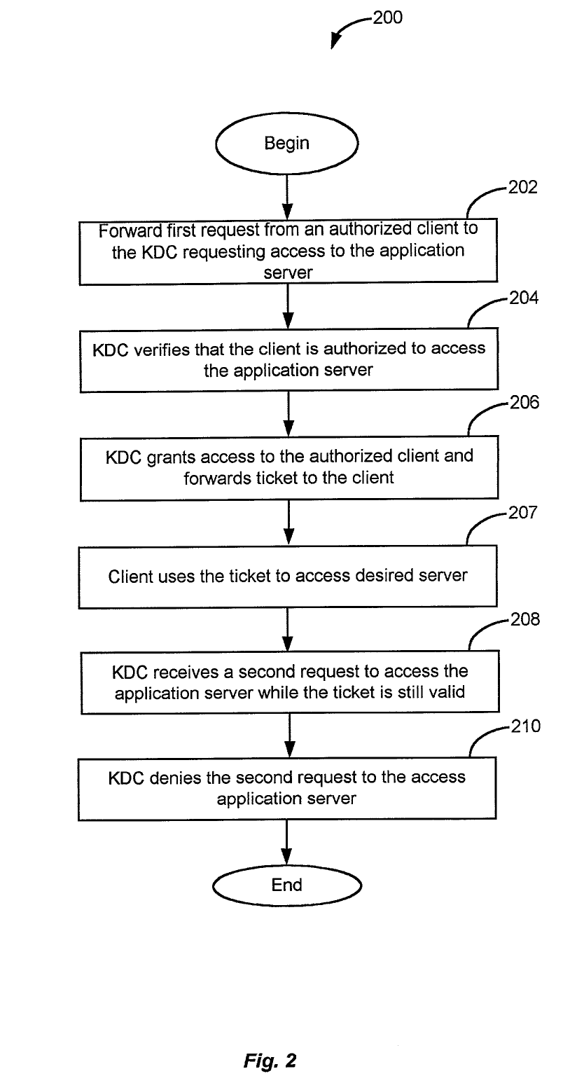

Among other components, communication network 100 includes a content provider 102 for generating content intended for an authorized client 116; and the Internet 114 through which the content is streamed to client 116. Communication network 100 further includes a provisioning server 104; and a KDC (key distribution center) 106 that contains an AS (authentication server) 110 for issuing a TGT (ticket granting ticket) to client 116; a TG (ticket granting) server 112 for providing server tickets to client 116 for access to particular servers such as application server 108; and a clone 118 which is an unauthorized duplicate identity of client 116. Clone 118 is prevented from accessing the requisite application servers in accordance with the principles and precepts of the present invention as further described with reference to FIG. 2.

Communication network 100 may be an IP telephony network, an audiovisual content delivery network or the like to which client 116 is a subscriber and is authorized to receive such content.

As used herein, a KDC 106 is a trusted authority for authenticating clients, and for distributing session keys between a client and an application server. These session keys establish secure sessions between the client and the application server. The application server may provide services to its clients, such as streaming media, downloads of MP3 songs, bandwidth authorization for VoIP sessions, etc. This KDC may be based on the Kerberos protocol which is based on an IETF (Internet engineering task force) standard. Or, it may be based on some other, proprietary protocol such as ESBroker, implemented by Motorola, Inc., of San Diego, Calif.

The Kerberos protocol provides encryption and authentication functionalities related to the client's ability to access content. The Kerberos protocol is well known in the art for providing client/server authentication. By using Kerberos, KDC 106 may provide a single user with access to multiple computing systems on the network. This is done by issuing a ticket to the user.

As used herein, a ticket is an authentication token provided to a client by the KDC. Among other information, a ticket contains the name of the client, name of a specific server and a session key (a symmetric encryption key). The client name and session key need to be kept secret and are encrypted with another key, called a service key. The service key is a secret key that is known only to the KDC and the server named in the ticket. Because the client does not also possess this service key, it does not have the ability to decrypt the ticket and change its contents. Normally, the client also needs to know the session key and since it cannot get it out of the ticket, the KDC sends to this client a separate copy of the same session key.

Briefly, in use, when client wishes to access application server 108 (or content provider 102), it contacts KDC 106. KDC 106 then verifies whether client 116 is authorized to access application server 108. This verification is done by performing an authenticated Diffie-Hellman key exchange. Diffie-Hellman is a well-known public key algorithm for negotiating symmetric keys. With this algorithm, each party on each end can generate the same symmetric key for encrypting/authenticating messages.

After client 116 is authenticated by KDC 106, it issues a ticket containing a session key. In one aspect, this ticket is valid for a designated duration. In another aspect, KDC 106 simply records when the ticket was issued. After the ticket is issued, the session key is used by client 116 for authenticating its access request and accessing application server 108. Once authenticated, access is granted to client 116.

The Diffie-Hellman key exchange forces all entities to contact KDC 106 to obtain access to application servers and content providers. This is because, with Diffie-Hellman, each party randomly generates a new public/private key pair before a new key exchange and only the public keys are exchanged over communication lines. Each party uses its own private Diffie-Hellman key and the public Diffie-Hellman key of the other party to generate an identical symmetric key on both sides. Thus, symmetric session keys cannot be duplicated by a clone that is simply snooping the line. In this manner, a clone wishing to access application server 108, needs to contact KDC 106 to perform its own authenticated key agreement, to obtain a ticket with a new random session key.

Clone 118 having duplicated the identity of client 116, now contacts KDC 106 to request access to application server 108. KDC 106 then checks whether the access request is prior to expiration of the ticket previously issued to the authorized client. If so, the access request is flagged as a possible fraudulent request. It is probable the access request is from clone 118, because authorized client 116 would not keep requesting for tickets while its ticket is valid.

Alternately, the access request may be denied after a designated number of requests. For example, the designated number of requests may be ten, after which further requests during the ticket validity period are denied. In this manner, the present invention grants access to authorized clients while preventing access to unauthorized clients.

FIG. 2 is a flow chart of a method 200 for detecting clone 118 in accordance with an embodiment of the present invention.

At step 202, method 200 comprises forwarding from client 116 to KDC 106, a first request to access content at application server 108. It is assumed that client 116, application server 108 and content provider 102 have pre-registered with KDC 106. The first request to access content involves a number of sub-steps. Specifically, client 116 transmits a message to authentication server 110 (FIG. 1). This message requests a TGT (ticket granting ticket) for accessing TG server 112. Note the TGT request message includes the client and the KDC's identity, and may contain a list of symmetric encryption algorithms that are supported by client 116.

At step 204, KDC 106 verifies that client 116 is authorized to access TGS server 112. In one embodiment, this verification is by performing an authenticated Diffie-Hellman key exchange. This results in generating a session key for the TGT (step 206, below).

A session key is either a direct result of a Diffie-Hellman key agreement based on public/private key pairs generated by the client and KDC 106, or it is another randomly generated key that is in turn encrypted with the result of the Diffie-Hellman key agreement. Since private values are not exchanged over the wire, it is computationally infeasible to determine the session key just from snooping on the line. This unfeasibility is even greater where the Diffie-Hellman key size is sufficiently large. By employing Diffie-Hellman, it is ensured that all entities wishing to receive a session key must communicate with KDC 106 as the session key cannot be snooped by a passive snooper on the communication line. One of ordinary skill in the art will realize that other algorithms consistent with the spirit and scope of the present invention may be employed.

Further, KDC 106 may check with provisioning server 104 for validity of client 116. Alternatively, KDC 106 may query a subscriber or consumer database (not shown) located in KDC 106 to determine validity of client 116.

At step 206, method 200 comprises issuing a TGT to client 116 for accessing TG server 112. In one embodiment, the TGT is valid for a predefined duration time T. That is, it has a start time and an end time. This information is recorded by KDC 106. Alternatively, KDC 106 may simply record when the TGT was issued. In this manner, future requests from clients with the same identifying information as client 116 may be monitored by TG server 112.

At step 207, client 116 sends an access request message to TG server 112. This message, accompanied by the TGT, requests a server ticket for accessing application server 108. In turn, TG server 112 authenticates the access request message using the TGT. Upon proper authentication, the server ticket is issued and sent to client 116.

In one embodiment, the server ticket (and not the TGT) is valid for a designated duration. In this fashion, clones are detected by TGS server 112 and not by server 110. The server ticket having being issued is used by client 116 for obtaining access to application server 108.

Clone 118 having duplicated the identity of client 116, wishes to access application server 108 (via TG server 112). Clone 118 has identifying information identical to client 116. This information may be the client's hardware (e.g., Ethernet) address, for example. Or, it may be other client identifiers.

Note that clone 108 may be any client seeking access to application server 108. In fact, it may be client 116 seeking a new ticket after losing the prior ticket during a system glitch, for example. In all likelihood, however, clone 118 is an unauthorized entity with the same identifying information as client 116. One would not normally expect the same client to keep requesting a ticket for the same application server while a prior ticket is valid. Such might be the case for example if the client somehow loses its ticket.

In order to access to application server 108, clone 118 must contact KDC 106. This requirement is a consequence of using the Diffie-Hellman key exchange algorithm. Although the client's identity has been cloned, the Diffie-Hellman key exchange prevents piracy of session keys because Diffie-Hellman key pairs are randomly generated for each key negotiation and thus cannot be distributed into clones in advance.

At step 208, clone 118 sends an access request message to authentication server 110 for a TGT. Authentication server 110 realizes that a ticket was previously issued to client 116 with identical identifying information as clone 114. Herein lies one advantage of the present invention.

At step 210, authentication server 110 checks whether this access request was received during time T. Note that time T is the validity period of the previously issued TGT at step 207.

If the TGT is still valid, the access request is flagged as a possible clone pending further investigation. Flagging ensures that clone 118 is marked, while the access request to TG server 112 is granted. Thus, it allows continued access in the event the access request is from an authorized entity that has lost its ticket, for example.

Alternately, this access may be denied to prevent access to the server. Such denial may occur after a designated number of requests. For example, the access request may be denied after six requests.

Advantageously, KDC 106 detects when a particular client keeps requesting a ticket for the same server more often than the ticket lifetime would dictate. In one embodiment, preferably, this detection is by authentication server 110, when a TGT for TG server 112 is requested by clone 118 (e.g. step 204).

Further yet, in another embodiment, detection may be performed at application server 108. When application server 108 receives a ticket from client 116, it records the session key and its validity period. When next application server 108 receives a ticket from the same client but with a different session key, it verifies whether the recorded session key is still valid. If so, the requesting entity is flagged or disabled in a similar manner as KDC 106, above. Note that requests appearing to originate from an authorized client with different key session keys may be clones. These clones may have different tickets, wherein each clone alternates sending tickets to the application server. Since a TG server 112 is one type of an application server, the same detection described for an application server can also be performed at a TG server 112, when a server ticket for application server 108 is requested (e.g. step 207).

In yet another embodiment, in FIG. 1, both TG server 112 and authentication server 110 are combined into a single component. In this manner, the clients need only send one request for access to application server 108. The step of obtaining a TGT for access to TGS server 112 is eliminated. Therefore, detection is performed by the single component KDC whenever a request for access to application server 108 is received.

In yet another embodiment, KDC 106 and application server 108 are combined. A client may request a TGT from KDC 106, where TGT is the same as other tickets. The TGT then provides access to the KDC itself.

In this fashion, the present invention provides a system for detecting duplicate identities in a network. While the above is a complete description of exemplary specific embodiments of the invention, additional embodiments are also possible. For example, the present invention is applicable to other security protocols, such as IKE (Internet Key Exchange). IKE is a point-to-point protocol (no trusted 3^{rd} party), where the two parties involved directly perform an authenticated Diffie-Hellman exchange.

The result of this exchange would be an ISAKMP (Internet Security Association and Key Management Protocol) or IPSec Security Association that also has a lifetime. If IKE is performed between a client and a server providing some pay service, the server may detect patterns when a particular client seems to change security associations too often, before the associations expire. This pattern may indicate that a client identity has been duplicated. Thus, the above description should not be taken as limiting the scope of the invention, which is defined by the appended claims along with their full scope of equivalents.

What is claimed is:

1. A method for detecting clones (unauthorized duplicate identities) of the client, the method comprising:
forwarding a first signal from a client to a KDC, the first signal for requesting access to a server;
verifying that the client is authorized to access the server;
transmitting a ticket from the KDC to the client, the ticket for providing access to the server, wherein the ticket is valid for a time T;
receiving a second signal from an entity, the second signal for requesting access to the server, wherein the entity has identifying information identical to the client; and
if the second request is received prior to expiration of the time T, either marking the entity as a possible clone or denying the second request in order to prevent access to the server.

2. The method of claim 1 further comprising
providing a session key in the ticket, the session key being valid for a designated duration.

3. The method of claim 2 wherein the designated duration is for determining the time T for which the ticket is valid.

4. A system for detecting clones of a client within a communication network, the system comprising:
a KDC;
an application server communicably coupled to the KDC;
a client for providing a first request to access the application server;
responsive to the first request, the KDC forwarding a first ticket for accessing the application server, the first ticket being valid for a time duration T;
the KDC receiving a second request to access the application server, the second request being received from an entity having identifying information identical to the client; and
if the second request is received during time T, the KDC denying the second request to prevent the entity from accessing the application server.

5. The system of claim 4 wherein the entity is a clone.

6. The system of claim 5 wherein the identifying information is a client identifier copied by the clone.

7. The system of claim 4 wherein the ticket further comprises an encrypted session key.

8. The system of claim 7 further comprising
the client deriving a copy of the session key for accessing the application server.

9. The system of claim 8 wherein the session key is derived using a key agreement algorithm.

10. The system of claim 9 wherein the key agreement algorithm is the Diffie-Hellman algorithm.

11. The method of claim 1 further comprising
using a key algorithm for authenticating communication between the KDC and the client such that all clients wishing access to the server are required to contact the KDC.

12. The method of claim 4 further comprising
requiring all entities wishing to access the server to communicate with the KDC.

13. A system for detecting clones (duplicate identities) of an authorized computing device in a communication network, the system comprising:
a first computing device;
a second computing device authorized to access the first computing device;
a key management means for providing to the second computing device, a session key for accessing the first computing device, the session key being invalid after a period T;
the key management means receiving one or more requests from an entity, to access the first computing device, the entity having identifying information identical to the second computing device; and
the key management means permitting the entity to access the first computing device, provided the number of access requests received during period T, is M or less requests.

14. The system of claim 13 wherein the key management means utilizes Diffie-Hellman key agreement algorithm to distribute session keys.

15. The system of claim 13 further comprising
the key management means flagging the entity if more than M requests are received from the entity.

16. The system of claim 13 wherein the identifying information is an identifier for the second computing device.

17. The system of claim 13 further comprising
the key management means denying access to the first computing device, if more than M requests are received.

18. A system for detecting clones of a client within a communication network, the system comprising:
a KDC;
a server communicably coupled to the KDC;
a client for receiving a ticket from the KDC, wherein the ticket is for accessing the server, and is valid for a time duration T;
the server receiving from the client a first request to access the server, the first request being accompanied by the ticket;
the server recording the time duration T for which ticket is valid;
the server receiving from an entity, a second request to access the server, the entity having identifying information identical to the client and
the server either flagging or denying the second request to prevent access to the server, if the second request is received during the time duration T.

19. The system of claim 18 further comprising
the KDC encrypting a session key within the ticket; and
the client extracting a copy of the session key in a manner that no entity other than the client can access the session key.

20. The system of claim 18 further comprising
necessitating by the system, all clients wishing to access the server to communicate with the KDC.

21. The method of claim 18 wherein a ticket granting server is the server, and the ticket is a ticket granting ticket.

22. A method for detecting clones in a communication network, the method comprising:
providing a ticket to an authorized client, the ticket for accessing a KDC, the ticket having a session key valid for a time duration T;
receiving a request to access the KDC, the request being received from an entity with the same identifying information as the authorized client; and
if the request is received during time T, flagging the entity as a possible clone or denying the request to access to the KDC.

23. The method of claim 22 wherein the ticket is a TGT (ticket granting ticket).

24. The method of claim 1 wherein the KDC marks the entity as a possible clone or denies the second request in order to prevent access to the server.

25. The method of claim 1 wherein the server marks the entity as a possible clone or denies the second request in order to prevent access to the server.

26. The method of claim 18 wherein the KDC is the server.
